(19) United States
(12) Patent Application Publication
(10) Pub. No.: US 2024/0403720 A1
(43) Pub. Date: Dec. 5, 2024

(54) ENHANCED PREDICTIVE MODELING USING TIME-SERIES TRAINING DATA

(71) Applicant: Legion Technologies, Inc., Santa Clara, CA (US)

(72) Inventors: Farshad Kheiri, Manhattan Beach CA, CA (US); Fatemeh Jafari, Kitchener (CA); Gopalakrishnan Sundaram, Saratoga, CA (US); Hanson Allen Egbert, Avila Beach, CA (US); Sanish Mondkar, San Francisco, CA (US); Nicolas Eduardo Escobar Pinzon, Bogotá (CO); Thomas A. Joseph, Atherton, CA (US)

(21) Appl. No.: 18/734,364

(22) Filed: Jun. 5, 2024

Related U.S. Application Data
(60) Provisional application No. 63/506,188, filed on Jun. 5, 2023.

(51) Int. Cl. G06N 20/00; G06N 5/022

(52) U.S. Cl. CPC G06N 20/00; G06N 5/022

(57) ABSTRACT

Methods, systems, and apparatus, including computer programs encoded on computer storage media, for enhanced predictive modeling. One of the methods includes obtaining a first prediction from a machine learning model trained to predict future events based on time-series data input; generating a set of one or more features of the first prediction; determining that the set of one or more features of the first prediction satisfy one or more thresholds indicating an event included in the first prediction is atypical; comparing the set of one or more features of the first prediction to one or more other features representing historical events that are included in the time-series data input; identifying, using the comparison, a set of historical events from the historical events that are included in the time-series data input; and generating an adjusted first prediction using the identified set of historical events.

### CROSS-REFERENCE TO RELATED APPLICATION

This specification claims the benefit of U.S. Provisional Pat. App. No. 63/506,188, filed Jun. 5, 2023, which is incorporated herein by reference.

### FIELD

The present specification describes predictive modeling techniques, including techniques that evaluate historical data with dynamically changing features, such as meteorological data, to improve the training and accuracy of predictive models.

### SUMMARY

In one example implementation, a system obtains a collection of time-series data indicating a number of features that change over time. The time-series data can include occurrences of historical events. A system can provide time-series data to a machine learning model that generates a prediction of future events. If a given predicted future event satisfies one or more thresholds indicating that the event is atypical, the system can adjust the given prediction. In some cases, the system adjusts a given prediction by identifying one or more similar previous events in the time-series data by comparing the features indicating the given event with features indicating events in the time-series data. Using the identified similar set of events, the system can adjust the given prediction to reduce prediction error.

In some cases, a predictive model can predict a likely malware event using historical time-series data indicating historical malware events. Traditional predictive models can generate erroneous predictions when presented with atypical conditions indicating a future event. Techniques described in this document include adjusting predictive model output using a subset of features indicating a predicted event and historical data for the given event. Adjustments can be used to enhance training data by converting atypical circumstances and corresponding events to typical circumstances and corresponding events. Adjustments can be generated by specific machine learning models that are trained using feedback from comparison error between adjusted predictions and obtained actual future events.

The predictive model can predict an event using various features, such as time of day, day of week, weather data, network traffic, transit traffic, scheduled digital or physical events, or a combination of these, among others. Features can have multiple elements that represent the feature, e.g., weather can be represented by temperature, rain amount, cloud cover, dew point, sunset and sunrise times, or a combination of these among others. Features can be represented by derived values, e.g., directionality of temperature over time, or a difference between a measured value and an average value. Other features that are not weather features could be used to enhance predictive model accuracy of other models as well.

A subset of features can be identified as important—e.g., features that have a statistical influence (i) that satisfies a threshold influence on an event occurring or (ii) that are more predictive than one or more other features regarding an event occurring—e.g., a model can be generated that iteratively learns to select features that increase an accuracy value or decreases a measure of error indicating a difference between a prediction and an actual future event that can be obtained in subsequent time-series data or in later time-series data not used for an initial prediction.

In some cases, features can be identified as having significant influence (e.g., statistical influence above a threshold or relative to other features) on a prediction and where values for those important features for the upcoming circumstance vary significantly from corresponding values in the training data for the predictive model (e.g., where variance satisfies one or more thresholds). Techniques described in this application include identifying other past circumstances that are similar to an upcoming circumstance. Techniques can include using historical data for similar circumstances to generate an adjustment factor to improve accuracy of a predicted variable. In some cases, if weather features are determined to be important features in a case where a predictive model is used for predicting store demand for an outdoor shopping mall, and if atypical weather is forecasted that has not occurred in the obtained time-series data, then the techniques described in this application can identify other historical data that can indicate an effect of the atypical weather event on demand, and can adjust the predicted demand based on that effect.

In some cases, training data itself can be adjusted instead of or in addition to adjusting a predicted variable. For instance, historical data used as training data can indicate various features of events that are atypical. Techniques described in this application can be used to generate adjusted training data that removes atypical aspects of the historical data using an adjustment based on similar events included in time-series data. In some cases, adjusting training data can help to prevent a trained predictive model from being skewed by atypical events. While some variation is acceptable and, indeed, can help improve an accuracy of a predictive model, events that satisfy an atypical threshold can reduce predictive model accuracy—e.g., because it is highly unlikely for the given features corresponding to the event to be repeated in the future.

In general, one innovative aspect of the subject matter described in this specification can be embodied in methods that include the actions of obtaining a first prediction from a machine learning model trained to predict future events based on time-series data input; generating a set of one or more features of the first prediction, wherein the set of one or more features indicate at least one of (i) a type of an event or (ii) preceding historical events; determining that the set of one or more features of the first prediction satisfy one or more thresholds indicating an event included in the first prediction is atypical; comparing the set of one or more features of the first prediction to one or more other features representing historical events that are included in the time-series data input; identifying, using the comparison, a set of historical events from the historical events that are included in the time-series data input, wherein the identified set of historical events include features that satisfy a threshold level of similarity with the set of one or more features of the first prediction; and generating an adjusted first prediction using the identified set of historical events. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: The actions include generating, using the adjusted first prediction, training data, wherein the training data represents one or more events indicated by the adjusted first prediction; and training the machine learning model using the generated training data. Feature 2: Generating the set of one or more features of the first prediction comprises: parsing the first prediction; and generating the set of one or more features using data parsed from the first prediction. Feature 3: Generating the set of one or more features using data parsed from the first prediction comprises: generating one or more features that match features included in the first prediction obtained from the machine learning model. Feature 4: Generating the set of one or more features using data parsed from the first prediction comprises: obtaining data indicating a time value; obtaining additional time-series data from a time-series data source within a time range from the time value; and generating, using the additional time-series data, the set of one or more features. Feature 5: Comparing the set of one or more features of the first prediction to the one or more other features representing historical events that are included in the time-series data input comprises: determining a distance within multi-dimensional space between a vector representing at least one of the set of one or more features of the first prediction and a vector representing at least one of the one or more other features representing historical events that are included in the time-series data input. Feature 6: Generating the adjusted first prediction using the identified set of historical events comprises: comparing a value representing a prediction of the identified set of historical events to a value representing the first prediction; and adjusting the first prediction using the comparison.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of a system that implements enhanced predictive modeling using time-series training data.

FIG. 2 is a flowchart of an example process for enhanced predictive modeling using time-series training data.

Like reference numbers and designations in the various drawings indicate like elements.

### DETAILED DESCRIPTION

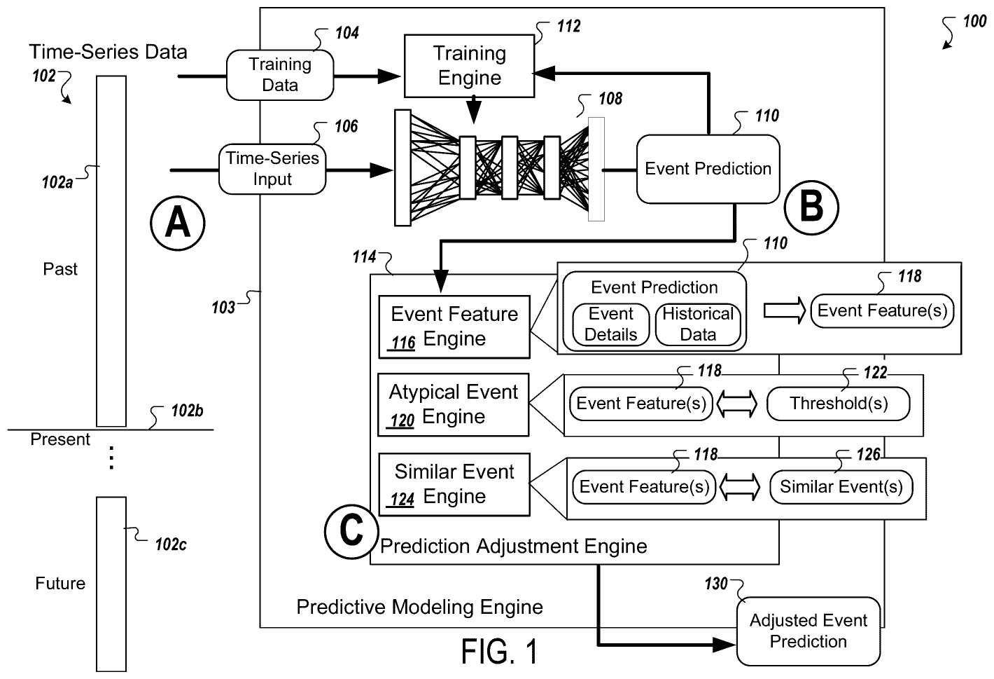

FIG. 1 is a diagram of a system 100 that implements enhanced predictive modeling using time-series training data. In general, the system 100 can improve predictive modeling by (i) adjusting future predictions that are determined to include atypical features and (ii) generating additional training data by adjusting historical data in obtained time-series data—e.g., to reduce atypical features that are unlikely to occur in the future. Briefly, the system 100 uses time-series data 102 to generate an adjustment, or correction, to the event prediction 110 in cases where features of the event prediction 110 indicate anomalous or an otherwise atypical environment, e.g., that can lead to model inaccuracies due to lack of training data for those unusual circumstances.

The system 100 includes a predictive modeling engine 103, a training engine 112, and a predictive adjustment engine 114. In some cases, the predictive modeling engine 103 includes at least one of the training engine 112 or the predictive adjustment engine 114. In some cases, the system 100 includes one or more computers that are configured to perform operations described in reference to FIG. 1.

The processes of FIG. 1 are described in reference to stages A-C. Briefly, in stage A, the system 100 obtains data from time-series data 102. In stage B, the system 100 generates an event prediction 110. In stage C, the system 100 adjusts the event prediction 110 to generate the adjusted event prediction 130. The following describes the processes of FIG. 1 in more detail.

In stage A, the system 100 obtains data from time-series data 102. For example, the predictive modeling engine 103 can obtain training data 104 and times-series input 106 from the time-series data 102. The time-series data 102 can include data indicating past events 102a before a present time 102b. After the present time 102b, the system 100 can obtain data indicating future events 102c. In some cases, the data indicating future events 102c can be used to train one or more machine learning models—e.g., where the system 100 generates error data indicating a difference between a prediction generated by the system 100 and an actual future occurrence and updates parameters or weights of one or more models using the error data.

The time-series data 102 can include an historical data set of features which can be represented by an expression, e.g., HD˜[fᵢ₁ . . . fiₙ] where fᵢ₁ . . . f_{iN} represent N features where N can be any number. The time-series data 102 can exist across one or more databases. For example, the system 100 can obtain data from one or more data sources as needed or periodically. In some cases, the time-series data 102 is grown iteratively with successive data transmissions from one or more data sources.

The time-series data 102 can include, for example, meteorological data for a location of an entity of interest, financial market information, biometric measurements, information that describes a state of a computer system, location information, inventory data, current event information, any changing or non-unchanging information. The time-series data 102 can be expressed in any format, and can be natural language information, information that's discernable to a machine, or any other information. In other words, the time-series data 102 can be any data. The time-series data 102 can be stored in a location that is accessible to the system 100, and may be reformatted, filtered, compressed, redacted or encrypted as is appropriate for use by the system 100.

The system 100 trains one or more machine learning models using the training data 104. For example, the training engine 112 of the system 100 can train the machine learning model 108. The training data 104 can include ground truth data that indicates events subsequent to historical data used as input for the machine learning model 108. For example, the training engine 112 can provide a first portion of the training data 104 as input to the machine learning model 108 and reserve a second portion of the training data 104, that represents time-series data subsequent to the first portion, as ground truth data. The training engine 112 can compare predictions of the machine learning model 108 with ground truth data to determine error data. The training engine 112 can use the error data to adjust the machine learning model 108. In some cases, the error data includes an absolute percentage error—e.g., for predictions that are represented numerically, the numerical prediction of the machine learning model 108 can be compared with a numerical ground truth with the error data representing the percentage difference between the two. In some cases, the machine learning model 108 includes one or more artificial neural networks, gradient boosting trees, random forests, or support vector machines.

In stage B, the system 100 generates an event prediction 110. For example, after the machine learning model 108 is at least partially trained using the training data 104, the system 100 can use the times-series input 106 to generate the event prediction 110. The event prediction 110 can indicate a future malware incidence, faults in building structures, demand in retail, among other predictions. The event prediction 110 can indicate a target of a predictive model that depends on a varying feature, such as weather, temporal features introduced by other dynamic entities, economic factors, or a combination of one or more of these among others. The event prediction 110 can be used for further training by the training engine 112 or be provided to the prediction adjustment engine 114.

In some cases, the machine learning model 108 can predict a variable based on values for features that collectively describe an upcoming circumstance. Values can be stored within the time-series data 102 as historical data or forecasted using one or more other predictive models or from one or more other sources, such as weather forecasting data. That data can be included in the time-series input 106—e.g., where future predictions can include a value representing likelihood and a predicted start or end time.

Values for features that collectively describe an upcoming circumstance can be captured in the time-series input 106. The model 108 can use various values in the time-series input 106 to generate the event prediction 110. Values in the time-series input 106 can include temporally variable features. Several examples of temporally variable features may include the temperature at a given location, which may vary significantly between day and night, and the amount of cloud cover at a given location, which can quickly change with the approach of a fast-moving storm. Some of these changes are anticipated, such as temperature fluctuations over the course of the day, and other are unusual, such as when an area is hit with a weather event that is unusual for an area

In some cases, the model 108 can include a prediction model that predicts, e.g., CPU usage of a device in a next segment of time, a number of items provided by a location offering items based on predicted temperature values ranges, discounts in place at the time of one or more circumstances, a number of sales personnel in each role that are planned to be in a store, opening or closing times that are scheduled for a location, a number of tickets sold at a nearby concert hall, demand for an entity such as a car wash business represented as car washes that will be performed at a future time, or generates any other prediction based on any other values or factors. Predictions can affect elements such as operating hours, the number and role of the employees are to be present, as well as adjustable parameters of machinery that is used to perform a car wash such as fluid levels, vehicle conveyer speed, scheduling of machine downtime, diagnostic reporting, inspection and maintenance downtime, or a combination of these among others. Such predictions might also affect the model 108 itself, for instance the type and quantity of training data that are to be used, as well as the frequency of retraining of the predictive model.

Certain feature values may not occur very often within a historical data set, such as the time-series data 102, rendering them statistically anomalous within the context of the training data. As a result, machine learning models may not easily discern and generalize the impact of such rare events, irrespective of the retraining frequency. This issue underscores the importance of developing more sophisticated modeling techniques that can robustly accommodate the inherent complexities and uncertainties associated with dynamic and non-stationary data.

When a predictive model is trained using training data that exhibits patterns within the training data, the model can generate predictions that have a higher accuracy. If fewer patterns are exhibited in the training data, the accuracy of the model can suffer. When the training data includes sets of feature values that can each vary significantly over time, it can be more difficult for the predictive model to discern patterns within the training data during the training process, which can negatively affect the accuracy of generated predictions.

In stage C, the system 100 adjusts the event prediction 110 to generate the adjusted event prediction 130. For example, the prediction adjustment engine 114 of the system 100 obtains the event prediction 110. The prediction adjustment engine 114 can include one or more components to process the event prediction 110, e.g., an event feature engine 116, an atypical event engine 120, and a similar event engine 124. Engines within other engines may be referred to as subengines. Briefly, the event feature engine 116 generates a set of features 118 using the event prediction 110, the atypical event engine 120 determines if the event prediction 110 includes one or more features that indicate the event prediction 110 includes an atypical event, and the similar event engine 124 identifies one or more similar events that are then used by the prediction adjustment engine 114 to adjust the event prediction 110 to generate the adjusted event prediction 130.

The event feature engine 116 generates the set of features 118 using the event prediction 110. The event feature engine 116 can use various elements indicated in the time-series data 102 or the event prediction 110 to generate the event features 118. The event features 118 can include at least one of event details or historical data. For example, the event feature engine 116 can identify event details for one or more events included in the event prediction 110. Event details can include a type of event—e.g., server side malware event, client side malware event, demand predictions for a specific product or specific entity providing the product, among others. Event details can include a time or location of an event—e.g., date, hours, minutes, or seconds or global positioning data, street address, or relative location, such as a proximity to one or more other locations.

Event details can be included in data representing the event prediction 110 or can be indicated by other data representing the event prediction 110. In the latter case, the event feature engine 116 can use one or more processes or models to determine event details based on the other data. For example, the event feature engine 116 can parse the event prediction 110 and identify a first element of the event prediction 110. The event feature engine 116 can then use the identified first element to search a database or other data source to identify event details. For example, the event prediction 110 can include a weather prediction that is represented with a first element that indicates a rain amount. Based on the first element indicating a rain amount, the event feature engine 116 can determine event details for the event prediction 110—e.g., where event details can indicate a type of event, such as a weather event type. In some cases, a classification model is used to choose, based on data representing the event prediction 110, which of a predetermined set of event details best matches the event prediction 110. The classification model can be trained based on human provided input indicating event details for a set of event predictions generated by one or more models.

In some cases, event details include severity or other event details. For example, event details can include one or more numerical or non-numerical values that represent an event prediction, such as the event prediction 110. Event details can be used for thresholding operations—e.g., to determine if an event is atypical or if an event is similar to one or more historical events.

The event feature engine 116 can identify historical data either in addition to, or instead of, event details. Similarly, the event feature engine 116 can identify event details in addition to, or instead of, historical data. Historical data can be included in the time-series data 102. Historical data can precede time indicating a time of one or more events included in the event detection 110. For example, historical data can indicate one or more historical events that occur before one or more events included in the event detection 110. If the event detection 110 includes, e.g., a future predicted demand at a location providing a service or product, the historical data can include weather events preceding the predicted demand, events occurring within a threshold proximity to the location providing a service or product, or other event details stored in the time-series data 102. Historical data in the time-series data 102 can be self-reported, e.g., by a user actively sending in data, or captured autonomously or semi-autonomously using one or more devices within a geographical area or over one or more connected components.

In some cases, the event feature engine 116 can obtain time-series data from one or more databases that store the time-series data 102. In some cases, the event feature engine 116 can parse the event prediction 110 to obtain historical data stored within the event prediction 110—e.g., the event prediction 110 can include one or more items of historical data, such as data that is statistically relevant or that had a larger than average effect on the output of the model 108. If the event feature engine 116 obtains time-series data from a data source, such as one or more databases, that store the time-series data 102, the event feature engine 116 can use a timestamp or other indication of time from the event prediction 110 and obtain data within a threshold time from that indicated time. In some cases, the threshold time can be dynamic—e.g., the event feature engine 116 can obtain more historical data for some events and less for others. For example, the event feature engine 116 can include one or more models that are trained to help optimize an amount of historical data that is obtained, e.g., based on event details of one or more events in the event prediction 110. Historical data that is determined or obtained by the event feature engine 116 can become a feature associated with the event prediction 110 for later processing steps.

The atypical event engine 120 determines if the event prediction 110 includes one or more features that indicate the event prediction 110 includes an atypical event. For example, the atypical event engine 120 can compare the event features 118 generated by the event feature engine 116 to one or more thresholds 122. The thresholds can be static or dynamic. In some cases, clustering processes can be used to determine outlier features. Outlier features can indicate that one or more associated events are atypical. Features 118 can be compared to one or more other previously determined features of previous events. In some cases, the atypical event engine 120 stores a set of historical features that are used by the atypical event engine 120 to determine if a given event, such as one or more events of the event prediction 110, are atypical.

In some cases, the atypical event engine 120 generates a set of one or more thresholds 122. The atypical event engine 120 can generate a threshold based on processing one or more historical features. The atypical event engine 120 can receive user input indicating various thresholds and then apply those thresholds. The atypical event engine 120 can include one or more models that generate thresholds—e.g., by predicting thresholds that correctly identify events as atypical or not using ground truth data that indicates which events used as input are atypical. The model can be adjusted based on error data generated by the atypical event engine 120 or another component of the system 100, such as the training engine 112, comparing output of the model with data representing the ground truth data.

The similar event engine 124 identifies one or more similar events that are then used by the prediction adjustment engine 114 to adjust the event prediction 110 to generate the adjusted event prediction 130. For example, the similar event engine 124 can use the event features 118 to identify similar events 126. The similar events 126 can be one or more events captured in the time-series data 102. In some cases, the similar event engine 124 only searches for similar events in response to the atypical event engine 120 determining that one or more events of the event prediction 130 are atypical. By searching only when one or more events are atypical, the system 100 can reduce processing bandwidth and compute time for processing one or more event predictions.

In some cases, the similar event engine 124 uses nearest neighbor searching to determine similar events stored in the time-series data 102. For example, the similar event engine 124 can access a set of items that each represent an event stored in the time-series data 102. Each item can have one or more features that represent the item. One or more of the features can be used to represent the item in multi-dimensional space. The similar event engine 124 can compare a multi-dimensional vector representing one or more events of the event prediction 110 with one or more other vectors representing one or more other historical events. In some cases, the similar event engine 124 can use a distance generation process to determine a multi-dimensional distance between one or more events of the event prediction 110 and one or more other historical events. In some cases, the similar event engine 124 determines that each item that satisfies a threshold distance from one or more events of the event prediction 110 qualifies as a similar event. A threshold can be dynamic, such as generated by iterative clustering processes, or static, such as equal to or less than 10 multi-dimensional units.

In some cases, features of an event can include the time or day of the event. Some features can be weighed more heavily for similarity calculations. For example, the similar event engine 124 can be more likely to identify events that occurred on the same day in previous year(s) as an event predicted to occur on that same day in the future even if other features are different. Similarly timed events can be an effective proxy for other features of a system, such as weather patterns, human behavior, daylight hours shifts, among others.

In some cases, similarity can be determined using features, such as important features, of events. Features can include weather metrics (e.g., snow, rain, etc.). Similarity can be determined using cosine similarity, e.g., using two or more vectors representing one or more features corresponding to events. In some cases, similarity can be determined using an aligned date. For example, an aligned date can be a date that shares temporal features with another date, such as the same date one year prior or the same day of the week, e.g., Monday.

In some cases, techniques include predicting future events by finding similar events in the past. For example, the predictive modeling engine 103 can identify features of an event, such as features that affect the event prediction or features that affect other future or historical events. In some cases, the event feature engine 116 generates features for one or more events. In some cases, the similar event engine 124 can identify one or more most representative historical datapoints, which can include data from aligned dates. In some cases, the similar event engine 124 uses a similarity determination, such as cosine similarity, to find similar events in the historical data using identified features at a vector-level.

In some cases, the predictive modeling engine 103 identifies a subset of features for processing by the predictive adjustment engine 114. For example, the predictive adjustment engine 114 can identify a subset of features generated by the event feature engine 116 as important, e.g., because similar features have been identified as statistically predictive of future events for historical events. Thus, the event features 118 can be a subset of a total number of features that can be associated with one or more events of the generated event prediction 110. By processing only a subset of features, the system 100 can reduce processing requirements and bandwidth compared to processing all features. Important features can be specified manually for a given type of event or for a give entity that is requesting event prediction. Important features can be generated by one or more trained models—e.g., trained to select which features are likely to be most predictive of future events.

The predictive adjustment engine 114 generates the adjusted event prediction 130. For example, the predictive adjustment engine 114 can determine one or more values indicating historical predictions of the similar events 126 and use those values to adjust the event prediction 110 to generate the adjusted event prediction 130. In some cases, the predictions can include numerical values, such as demand represented as an expected number of sold items or expected amount of CPU memory space to be used by a computer in a next X seconds. For a CPU processing prediction example, the historical predictions, for the similar events 126, can include a prediction of 360 mB. In some cases, the predictive adjustment engine 114 can adjust a prediction using a ratio of the historical predictions and the current predictions—e.g., historical, or a mean, median, or other average of multiple historical values, over a current prediction value. For the case of CPU prediction, a value of 360 mB can be used with a current prediction value, e.g., 500 mB to generate an adjustment factor, such as 360 mB/500 mB or 0.72. The predictive adjustment engine 114 can apply the factor to the current prediction, e.g., the event prediction 110 using multiplication.

In some cases, other adjustment mechanisms can be used. For example, instead of adjustment factors, the predictive adjustment engine 114 can use averaging to generate an average of historical values and current values indicating predictions and generate the adjusted prediction as the averaged value. In some cases, a weighted average can be used where one or more historical events are weighted depending on their determined similarity (e.g., by the similar event engine 124) or other value. In effect, this can skew an adjusted value towards the most similar identified historical event and away from a current prediction which, as stated, may be inaccurate due to atypical features identified by the atypical event engine 120.

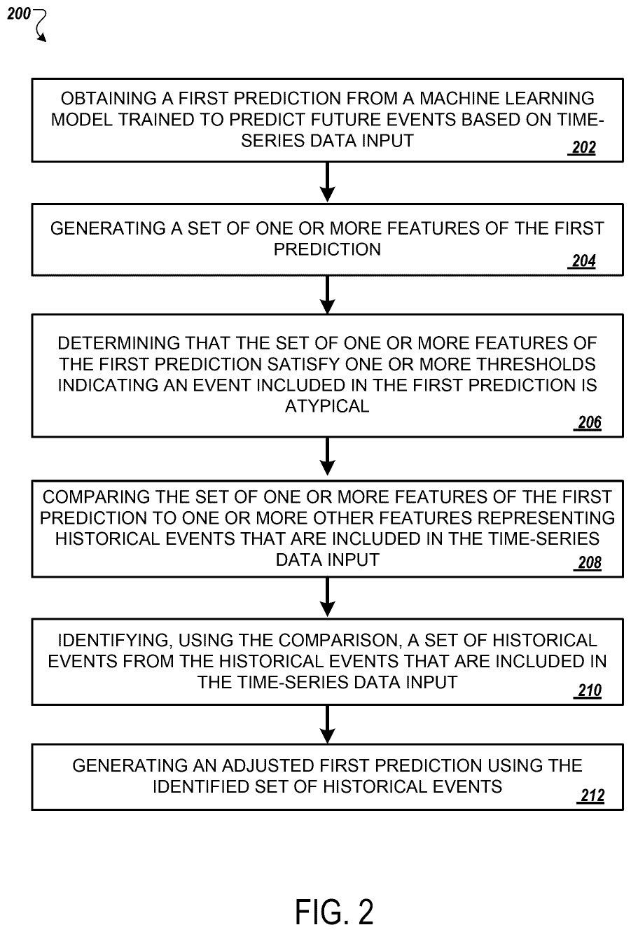

FIG. 2 is a flowchart of an example process 200 for enhanced predictive modeling using time-series training data. For convenience, the process 200 will be described as being performed by a system of one or more computers, located in one or more locations, and programmed appropriately in accordance with this specification. For example, the system 100 of FIG. 1, appropriately programmed, can perform the process 200.

The process 200 includes obtaining a first prediction from a machine learning model trained to predict future events based on time-series data input (202). For example, the predictive adjustment engine 114 can obtain the event prediction 110 from the machine learning model 108.

The process 200 includes generating a set of one or more features of the first prediction (204). For example, the event feature engine 116 can generate the event feature(s) 118 using the event prediction 110. The set of one or more features, such as the event feature(s) 118, can indicate at least one of (i) a type of an event or (ii) preceding historical events.

The process 200 includes determining that the set of one or more features of the first prediction satisfy one or more thresholds indicating an event included in the first prediction is atypical (206). For example, the atypical event engine 120 can determine that the event feature(s) 118 satisfy one or more threshold(s) 122.

The process 200 includes comparing the set of one or more features of the first prediction to one or more other features representing historical events that are included in the time-series data input (208). For example, the similar event engine 124 can compare the features 118 with one or more features included in the time-series data 102, e.g., one or more features of the similar events 126.

The process 200 includes identifying, using the comparison, a set of historical events from the historical events that are included in the time-series data input (210). Fe, the similar event engine 124 can identify the similar events 126 using the comparison of the features 118 with one or more other features included in the time-series data 102. The identified set of historical events can include features that satisfy a threshold level of similarity with the set of one or more features of the first prediction.

The process 200 includes generating an adjusted first prediction using the identified set of historical events (212). For example, the predictive adjustment engine 114 can generate the adjusted event prediction 130. In some cases, the predictive adjustment engine 114 can generate the adjusted event prediction 130 using a factor-based adjustment, where the factor is generated based on the set of historical events identified using the comparison.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

In this specification, the term “database” is used broadly to refer to any collection of data: the data does not need to be structured in any particular way, or structured at all, and it can be stored on storage devices in one or more locations.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining a first prediction from a machine learning model trained to predict future events based on time-series data input;
generating a set of one or more features of the first prediction, wherein the set of one or more features indicate at least one of (i) a type of an event or (ii) preceding historical events;
determining that the set of one or more features of the first prediction satisfy one or more thresholds indicating an event included in the first prediction is atypical;
comparing the set of one or more features of the first prediction to one or more other features representing historical events that are included in the time-series data input;
identifying, using the comparison, a set of historical events from the historical events that are included in the time-series data input, wherein the identified set of historical events include features that satisfy a threshold level of similarity with the set of one or more features of the first prediction; and
generating an adjusted first prediction using the identified set of historical events.

2. The method of claim 1, comprising:
generating, using the adjusted first prediction, training data, wherein the training data represents one or more events indicated by the adjusted first prediction; and
training the machine learning model using the generated training data.

3. The method of claim 1, wherein generating the set of one or more features of the first prediction comprises:
parsing the first prediction; and
generating the set of one or more features using data parsed from the first prediction.

4. The method of claim 3, wherein generating the set of one or more features using data parsed from the first prediction comprises:
generating one or more features that match features included in the first prediction obtained from the machine learning model.

5. The method of claim 3, wherein generating the set of one or more features using data parsed from the first prediction comprises:
obtaining data indicating a time value;
obtaining additional time-series data from a time-series data source within a time range from the time value; and
generating, using the additional time-series data, the set of one or more features.

6. The method of claim 1, wherein comparing the set of one or more features of the first prediction to the one or more other features representing historical events that are included in the time-series data input comprises:
determining a distance within multi-dimensional space between a vector representing at least one of the set of one or more features of the first prediction and a vector representing at least one of the one or more other features representing historical events that are included in the time-series data input.

7. The method of claim 1, wherein generating the adjusted first prediction using the identified set of historical events comprises:
comparing a value representing a prediction of the identified set of historical events to a value representing the first prediction; and
adjusting the first prediction using the comparison.

8. One or more computer-readable storage media encoded with instructions that, when executed by one or more computers, cause the one or more computers to perform operations comprising:
obtaining a first prediction from a machine learning model trained to predict future events based on time-series data input;
generating a set of one or more features of the first prediction, wherein the set of one or more features indicate at least one of (i) a type of an event or (ii) preceding historical events;
determining that the set of one or more features of the first prediction satisfy one or more thresholds indicating an event included in the first prediction is atypical;
comparing the set of one or more features of the first prediction to one or more other features representing historical events that are included in the time-series data input;
identifying, using the comparison, a set of historical events from the historical events that are included in the time-series data input, wherein the identified set of historical events include features that satisfy a threshold level of similarity with the set of one or more features of the first prediction; and
generating an adjusted first prediction using the identified set of historical events.

9. The media of claim 8, wherein the operations comprise:
generating, using the adjusted first prediction, training data, wherein the training data represents one or more events indicated by the adjusted first prediction; and
training the machine learning model using the generated training data.

10. The media of claim 8, wherein generating the set of one or more features of the first prediction comprises:
parsing the first prediction; and
generating the set of one or more features using data parsed from the first prediction.

11. The media of claim 10, wherein generating the set of one or more features using data parsed from the first prediction comprises:
generating one or more features that match features included in the first prediction obtained from the machine learning model.

12. The media of claim 10, wherein generating the set of one or more features using data parsed from the first prediction comprises:
obtaining data indicating a time value;
obtaining additional time-series data from a time-series data source within a time range from the time value; and
generating, using the additional time-series data, the set of one or more features.

13. The media of claim 8, wherein comparing the set of one or more features of the first prediction to the one or more other features representing historical events that are included in the time-series data input comprises:
determining a distance within multi-dimensional space between a vector representing at least one of the set of one or more features of the first prediction and a vector representing at least one of the one or more other features representing historical events that are included in the time-series data input.

14. The media of claim 8, wherein generating the adjusted first prediction using the identified set of historical events comprises:
comparing a value representing a prediction of the identified set of historical events to a value representing the first prediction; and
adjusting the first prediction using the comparison.

15. A system comprising:
one or more computers and one or more storage devices on which are stored instructions that are operable, when executed by the one or more computers, to cause the one or more computers to perform operations comprising:
obtaining a first prediction from a machine learning model trained to predict future events based on time-series data input;
generating a set of one or more features of the first prediction, wherein the set of one or more features indicate at least one of (i) a type of an event or (ii) preceding historical events;
determining that the set of one or more features of the first prediction satisfy one or more thresholds indicating an event included in the first prediction is atypical;
comparing the set of one or more features of the first prediction to one or more other features representing historical events that are included in the time-series data input;
identifying, using the comparison, a set of historical events from the historical events that are included in the time-series data input, wherein the identified set of historical events include features that satisfy a threshold level of similarity with the set of one or more features of the first prediction; and
generating an adjusted first prediction using the identified set of historical events.

16. The system of claim 15, wherein the operations comprise:
generating, using the adjusted first prediction, training data, wherein the training data represents one or more events indicated by the adjusted first prediction; and
training the machine learning model using the generated training data.

17. The system of claim 15, wherein generating the set of one or more features of the first prediction comprises:
parsing the first prediction; and
generating the set of one or more features using data parsed from the first prediction.

18. The system of claim 17, wherein generating the set of one or more features using data parsed from the first prediction comprises:
generating one or more features that match features included in the first prediction obtained from the machine learning model.

19. The system of claim 17, wherein generating the set of one or more features using data parsed from the first prediction comprises:
obtaining data indicating a time value;
obtaining additional time-series data from a time-series data source within a time range from the time value; and
generating, using the additional time-series data, the set of one or more features.

20. The system of claim 15, wherein comparing the set of one or more features of the first prediction to the one or more other features representing historical events that are included in the time-series data input comprises:
determining a distance within multi-dimensional space between a vector representing at least one of the set of one or more features of the first prediction and a vector representing at least one of the one or more other features representing historical events that are included in the time-series data input.
